(19) United States
(12) Patent Application Publication
(10) Pub. No.: US 2002/0013906 A1
(43) Pub. Date: Jan. 31, 2002

(54) Secure medical test and result delivery system

(76) Inventors: Walter Wallach, Los Altos, CA (US); Scott Adams, Los Gatos, CA (US)

Correspondence Address: Larry E. Vierra, Esq., VIERRA MAGEN MARCUS HARMON & DENIRO, 685 Market Street, Suite 540, San Francisco, CA, 94105-4206, US

(21) Appl. No.: 09/881,181

(22) Filed: Jun. 14, 2001

Related U.S. Application Data
(60) Provisional application No. 60/211,696, filed on Jun. 14, 2000.

(51) Int. Cl. H04L 9/00; H04K 1/00

(52) U.S. Cl. 713/185

(57) ABSTRACT

A system and method for obtaining controlled information delivery of many kinds from a test taker. In one aspect, the system and method provide a medical test device delivery, retrieval and data distribution system in a secure and efficient format. In this aspect, the method comprises: transmitting a data collector to an end user; collecting the data collector from the end user; and transmitting user data from the collector to authorized users. The step of transmitting may comprise shipping a medical test device to a patient, and may further comprise the sub-steps of accepting a request to ship a device from a requesting user; and communicating with a shipper directing shipment to the end user. In the aforementioned method, the user must be authorized to make the request for the shipment. The method may further comprise distributing the results of the test to the user via a combination of public and/or private networks. In a further aspect, the invention comprises a method for distributing a test device and providing test results to authorized users. In this aspect, the method may comprise the steps of collecting an order for a device; transmitting a test device to a user; retrieving the test device from the user subsequent to the user imputing data into the device; extracting test results from the test device; and transmitting test results to an authorized individual. In a further aspect, the collection step may be performed using an information server coupled to a public network and include the sub-step of verifying the end user as having authorized transmission of the data collector to the end user.

### BACKGROUND OF THE INVENTION

1. Field of the Invention

The invention relates to the collection and dissemination of confidential data. In particular, the invention relates to the ordering of medical tests, delivery and retrieval of medical test devices, control of medical test information, and secure and efficient distribution of the information to authorized physicians.

2. Description of the Related Art

A number of medical tests require data collection from a patient over a lengthy period of time. Often, such tests must be performed in a controlled environment to ensure the accuracy of the test results. However, new tests are constantly being developed in areas traditionally requiring such laboratory testing which allow the patient to provide test data in a more comfortable environment, such as their home.

One particular field of medical testing where home testing can provide a significant advantage over traditional laboratory testing techniques is in the field of sleep apnea. Sleep apnea is among the most common and most dangerous types of sleep disorder. The condition is marked by repeated episodes of cessation of breathing during sleep that over time can lead to high blood pressure, cardiac disease, and disordered thinking. Obstructive sleep apnea is by far the most common type. Breathing is interrupted when air can't flow into or out of the nose or mouth. The reason for the blockage could be an over-relaxation of the throat muscles and tongue, which partially blocks the airway or, in obese people, an excess amount of tissue in the airway. In the less common form, central sleep apnea, breathing is stopped not because the airway is closed but because the diaphragm and chest muscles stop working.

Traditionally, before being diagnosed with sleep apnea, a patient must submit to testing at a specialized sleep laboratory. The laboratory includes feedback equipment to measure a patient's physical reactions and brainwave activity during sleep testing which is performed at the site. The patient may be forced to attempt to sleep in a laboratory room with a bed which may be observed by the test technician. As such, this methodology is quite time consuming. Moreover, because of the limitations in the availability of facilities and trained technicians, the overall diagnosis can take several months: there is an initial delay in scheduling the laboratory time, followed by the all night or multiple night exam at the laboratory, further followed by several weeks delay in providing the results of the exam to the patient's physician.

When the test is completed, the results are analyzed and interpreted by a physician at the sleep lab. Typically this physician charges a fee for this over and above the fee for the test.

For the patient's physician, the current practice of referring a patient to a sleep lab often means that the patient comes under the care of the sleep lab physicians, and the physician referring the patient loses control of the patient. This presents a business problem for the referring physician and a discontinuity in patient care. If non-surgical treatments fail, the referring physician (often a surgeon specializing in pulmonology or otolaryngology) may or may not have an opportunity to treat the patient because the patient may not return to the referring physician who many times can best treat the patient.

In addition, conventional testing of a patient for sleep apnea in a sleep lab is expensive and not necessarily representative of the patient's normal behavior. The expense presents a problem for patients who are paying for the test themselves, and increases the cost borne by the health insurance carriers.

As a result, devices have been developed which allow physicians to test for sleep apnea in the home. Devices such as those disclosed in U.S. Pat. Nos. 5,797,852 and 5,844,996 provide feedback to physicians following a period of in-home testing by a patient. Typically the patient has to go to the physician's office or sleep lab to have the test device placed on them, and the patient thereafter carries the device home for a one-night test. The test device is then hand-carried by the patient to the physician, who extracts data from the device and provides it to the physician who requested the test.

Delivery, retrieval and tracking of these test devices present logistical issues for a test facilitator. For example, a physician typically requests that a patient be tested by having the patient make an appointment to visit the sleep lab. There, the patient is physically connected to a test device, and sent home with wires attached to various parts of his or her body. The identity of the patient being tested is maintained through the patient carrying the device back to the sleep lab the next morning. The results of a test are typically mailed or sent by fax to the requesting physician's office. Thus, current practice does not facilitate ordering of sleep apnea tests for patients, nor does it facilitate delivery and retrieval of home testing devices or the identification of the patient whose test data is captured a particular device. Finally, current practice does not facilitate the secure delivery of confidential medical test results to everyone authorized by the patient to receive them.

Delivery issues exist with treatment as well as diagnosis. For example, the most common effective treatment for obstructive sleep apnea is nasal continuous positive airway pressure, or CPAP. The patient wears a soft plastic mask over his or her nose while sleeping. A device supplies pressurized room air through a flexible tube attached to the mask. The pressurized air acts as a stent to prevent the airway from collapsing. To prescribe CPAP treatment, the physician must first order a CPAP titration. The patient is typically sent back to the sleep lab for the titration step. If a CPAP is indicated, the patient is sent to a medical device vendor with a prescription for a device with the proper treatment setting. The patient then takes the device home with them. In some cases, the patient picks up a titration unit from a sleep lab in order to test it themselves at home. The patient returns this device, and its pressure readings are extracted and used for calibration and setting of the correct pressure for the CPAP machine.

Patients are typically seen initially by a primary care physician, who does not specialize in sleep disorders. This physician then refers the patient to a specialist, who manages the initial diagnosis. As explained above, the specialist often must refer the patient a second time to a sleep lab, which manages and evaluates the sleep test, and often prescribes the non-surgical treatment. The referral process usually involves paperforms. Presently, there is no process or capability available which simplifies this referral process for the primary care physician, and facilitates the specialist's sharing information with the primary care physician. This process gets more cumbersome when more than one specialist is involved (for example, a primary care physician with a patient with sleep apnea, and resulting cardiac problems).

There are other medical conditions where a patient must be monitored and data collected as they proceed with “normal” aspects of their lives. One example is cardiac monitors. These are ordered by a cardiac physician, and must be delivered to the patient, collected data must be retrieved and analyzed, and results must be distributed securely to the proper authorized individuals.

### SUMMARY OF THE INVENTION

The invention, roughly described, comprises a system and method for an authorized requestor to cause a medical test device to be delivered to a patient, and for retrieving data collected by the device (and, optionally, the test device), and for the controlled and secure distribution of the results of the test collection to the authorized requestor and/or other authorized parties.

The invention further comprises a method for securely collecting information from a user, comprising transmitting a data collector to an end user; collecting the data collector from the end user; and transmitting user data from the collector to authorized users.

In another embodiment, the invention is a method for collecting data, comprising: providing a test apparatus to a user; collecting the testing apparatus from the user once the user completes testing; and providing test information from the apparatus to authorized users.

In yet another embodiment, the invention is a method for distributing a test device and providing test results to authorized users, comprising: collecting an order for a device; transmitting a test device to a user; retrieving the test device from the user subsequent to the user imputing data into the device; extracting test results from the test device; and transmitting test results to an authorized individual.

The method finds particular application when an Internet connection is used to order a test device, and distribute the results of test collection devices to authorized users of the system.

### BRIEF DESCRIPTION OF THE DRAWINGS

The invention will be described with respect to the particular embodiments thereof. Other objects, features, and advantages of the invention will become apparent with reference to the specification and drawings in which:

FIG. 1A is a flow diagram illustrating the general process of the present invention.

FIG. 1B is a flow chart of a first embodiment of a method in accordance with the present invention for test ordering, data collection and secure transmission of collected data to authorized users.

FIG. 2 is a process-oriented block diagram of the overall system of the present invention including both Internet-based and telephone-based (voice and fax) ordering, and dissemination of collected data to authorized parties.

FIGS. 3A and 3B are flow diagrams demonstrating the process of the present invention as implemented in one embodiment of the system of the present invention.

FIG. 4 is a block level diagram of the data structure utilized in accordance with the system of the present invention and the tables found therein.

FIGS. 5-8 are use-case diagrams illustrating the portions of the system services which are available to different classes of authorized requestors in accordance with the system of the present invention.

### DETAILED DESCRIPTION

The present invention provides a unique system and method for secure test ordering, data collection, and the secure distribution of collected data to authorized parties. The system of the present invention has particular application to the field of home medical testing. In the system of the present invention, doctors are provided with a system for securely ordering home medical tests which can be delivered to a patient: patients are provided with the means to allow the test to be ordered and delivered to them in the convenience of their own home; and confidentiality and privacy are maintained through secure distribution of the results of the home medical test to the doctor in a variety of formats. In one particular embodiment, the system is adapted for home testing of patients for sleep apnea. In this embodiment, a home sleep study is prescribed by an authorized physician, a home sleep apnea test device is provided to a patient, a test is performed at the patient's home, the test device is returned to a receiving location, and the results retrieved from the device. Alternatively, results can be retrieved from the device (through a data connection by telephone or wireless, for example) prior to its return from the patient. The physician who ordered the test may thereafter view the results of the test on a secure link between the physician and the patient. The entire period from first ordering the test to when results are available is substantially shorter than has been known in the prior art, and through a number of alternative mechanisms.

As discussed herein, other types of diagnostic devices may be provided to patients using the present system. Further, the present invention may be used to order, deliver and return various types of treatment devices, and data for configuring or calibrating the treatment devices returned to the distributor of the devices to ensure that treatment configuration is correct for the patient. The data collection system may alternatively be used with health surveys, questionnaires, or other products or services offered by the system administrator.

The system includes software and hardware systems for order tracking, device tracking, data tracking, and interfaces to functional sub-systems. Such functional sub-systems may include courier services to provide distribution of tests from a central testing facility to patients in their homes, as well as information retrieval and device reconditioning facilities staffed by individuals trained to perform specific functions described herein. The system can be adapted for use in intra-enterprise environments, such as hospitals, to allow for tests to be distributed to patients' rooms, and the test results returned to the doctor in an efficient and more timely manner than has been performed in the prior art.

General System Overview

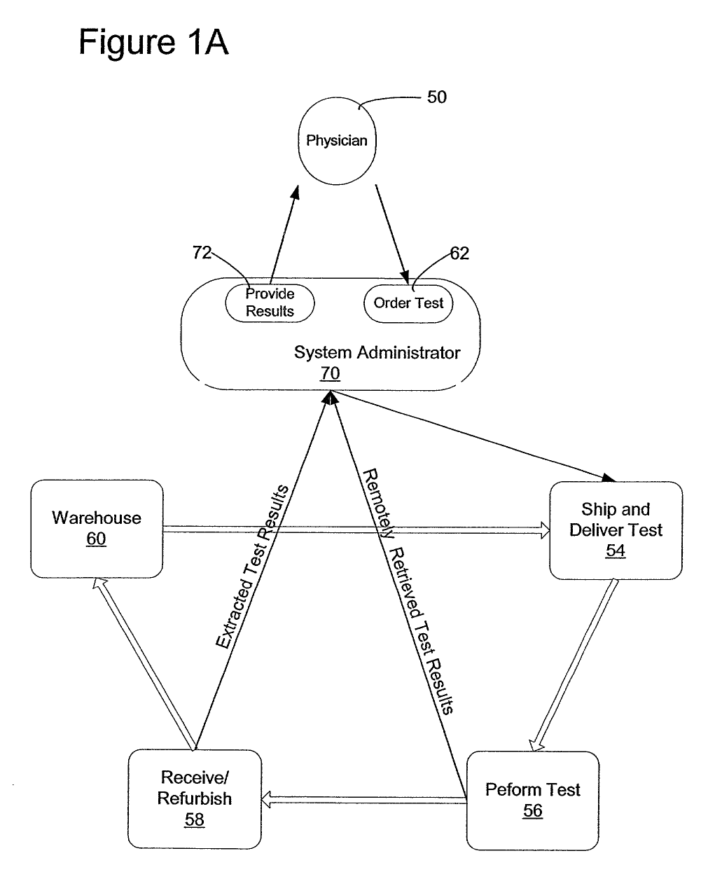

FIGS. 1A-B illustrate various embodiments of the method of the present invention. FIG. 1A illustrates the general steps of the method; FIG. 1B illustrates the method used with a sleep apnea test device.

FIG. 1A is a general flow diagram of the general method of the present invention. Unless otherwise indicated, steps in the method are performed by a system administrator or agents acting under the control of the system administrator. As defined herein, the “system administrator” is an entity responsible for providing and maintaining the system of the present invention, managing the data collection tasks of the system and method of the present invention through direct action or through communications with other physical entities such as contractors or commercial services operating the sub-systems defined herein, including both the computer processing portions and physical, human module service portions of the system.

FIG. 1A shows a general process whereby a physician 50 may order a test at step 62 from a system administrator 70. The system administrator controls the steps of shipping and delivering the test 54, and retrieving and refurbishing the test 58 and warehousing the test 60. The system administrator arranges for shipment and delivery of the test 54 to a person who is going to perform the test, such as the patient. Once the test is shipped and delivered after step 54, the patient performs the test at step 56. At this point, the test results may be remotely retrieved from the test device which still remains with the patient. Next, the device is retrieved and refurbished at step 58. Upon retrieval and refurbishment, test results may be retrieved if they have been yet remotely retrieved, or they may be retrieved as a verification that the results retrieved following step 56 were in fact accurate. Following refurbishment at step 58, the test device is warehoused until another shipment delivery request is made at step 54. The system administrator 70 provides the rest results at step 72 back to the physician assuming that the physician is authorized to receive the results. Provision of results at step 72 may be made to other individuals who are authorized to receive the results.

FIG. 1B shows the process of FIG. 1A in a flow chart from the perspective of the system administrator for any data collection device and specifically for a sleep apnea test device delivered to a patient's home. At step 100, an order for a test is received from an authorized requestor for a test for a patient. As noted, this requestor may be any user defined in the system who is authorized to place orders for any type of data collection device (i.e., a specialist ordering a test for a patient).

A requestor may input an order via a telephone, facsimile-transmitted order form, or using an Internet browser (using an encrypted connection via SSL, for example, for security). As described below, this action will create a database entry which includes a unique identifier for the patient and the specific test and begin the process.

After receiving an order at step 100, an authorization query step 103 determines whether the order for a data collection device is authorized. If the person placing the order is not authorized at authorization step 103 the process terminates, or more information may be gathered in order for the person to become authorized to order the data collection device. If the order is authorized, then a request to deliver a device (a shipping order) is created (step 105). Step 105 may involve additional steps (not specifically illustrated here, but described further below), involving readying the device for shipment and communicating with a shipper to deliver the device to the patient. At step 110, the device is delivered to the patient. The delivery step 110 can be performed by any form of courier service, including commercial courier services such as Federal Express® and/or United Parcel Service (UPS)®. The device may also be delivered to a “will-call” location for patient pickup, and returned by the patient to a similar “drop-off” location. The courier will pick from inventory and ship a collection device at step 110, providing an order acknowledgment 115 to the tracking and data management function 150. For simplicity, the same courier or shipping service would be used, with the return shipment prepaid.

An acknowledgment that the device is available for delivery and that the shipping order from step 105 has been received is provided at step 115 and returned to a tracking and data management 150. When the device actually ships, a separate shipping notice 125 is returned to tracking and data management 150. It should be noted that acknowledgement 115 and notice 125 are optional. After the patient receives the device, the data is input at step 120. The patient is responsible for returning the device through the appropriate mechanism, such as those described below, to the system administrator or a receiving agent of the administrator in step 125. As further detailed, the return mechanism is arranged prior to delivery of the device to make the return of the device a simple matter for the patient. At decision step 130, a check is made to determine whether the device has, in fact, returned. If the device is not returned, actions at step 135 may be taken to recover the device. If the device is returned, at step 140, the device is received by the system administrator, or a designated receiving agent, and data from the test is extracted. Test data 145 is returned to tracking and data management function 150. Data may be processed or analyzed at this time, or data may be processed or analyzed prior to reporting. Subject to ensuring that a recipient is, in fact, authorized to receive test results (decision box 155), the results may be distributed at step 160 by the system administrator. Actual results are always under the control of the system administrator. An alternate data extraction path is shown from patient inputting data in step 120 directly to the tracking and data management 150 (data 120), bypassing the physical return of the device (steps 125, 130, 140).

Medical Test Delivery and Retrieval System

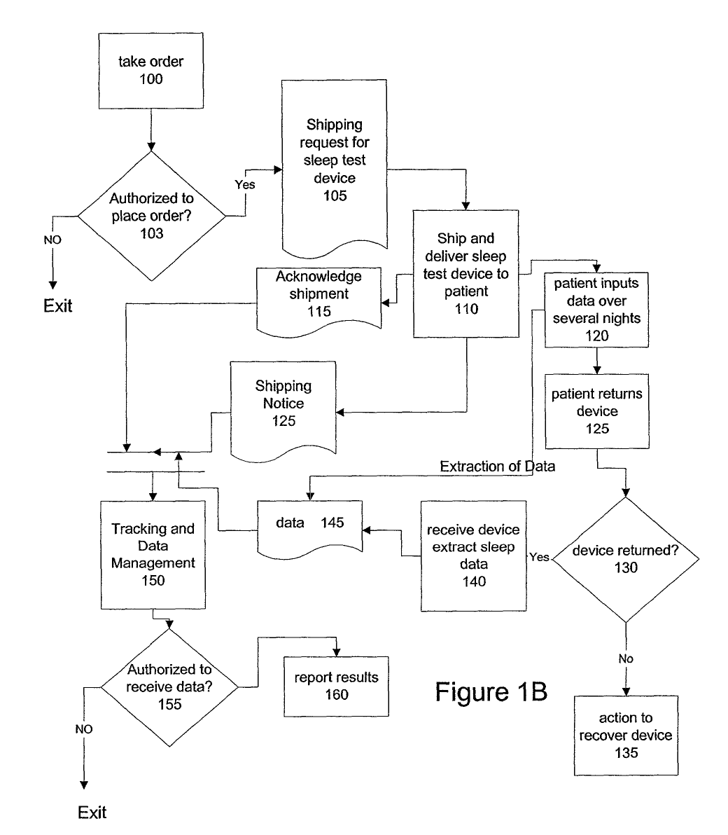

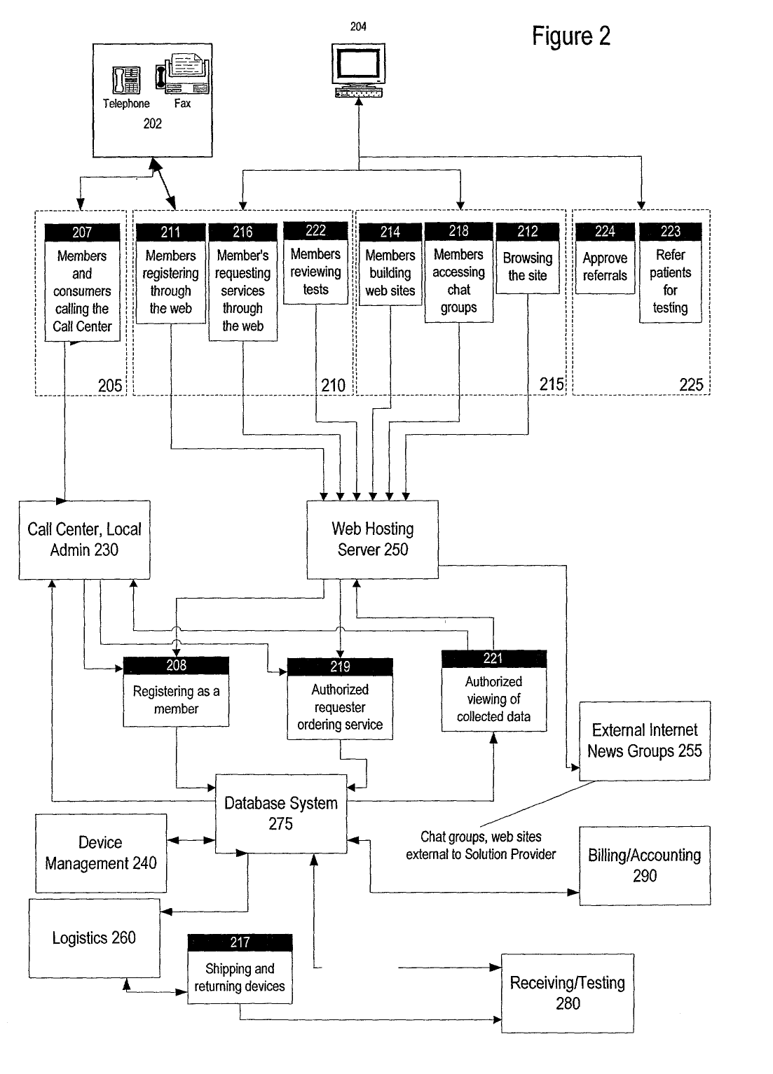

FIG. 2 shows an overview of the functional components of the system of the present invention, including a number of sub-systems (including both hardware, software and physical facilities) and classes of processes used in the system. The system shown in FIG. 2 may be used to implement the general process of the present invention shown in FIGS. 1A-1B and the specific method shown in FIGS. 3A-3B.

FIG. 2 illustrates two types of interactive mechanisms utilized in accordance with the system of the present invention: telephone and fax devices 202 and a computer terminal 204. Terminal 204 may represent a terminal connected to a global communications network such as the Internet. The interactive mechanism allows all levels of users to interact in certain types of processes with the system of the present invention. Also shown in FIG. 2 are seven general groups of processes with which varying levels of users may interact.

The embodiment shown in FIG. 2 is organized to service a number of different types of individuals accessing the system. Such individuals may include physicians, patients and consumers, and may request different services based on their method of accessing the system and whether or not they have registered with the system administrator.

As shown in FIG. 2, a non-computer-accessed set of processes indicated by dashed line 205 is only available through a telephone or fax-service-type. Process group 207 comprises members and consumers registering and requesting services from the system via a telephone call center through a human operator, or through a fax machine. A second set of processes (indicated by dashed line 215) are computer-accessed services available to members only through Internet access. Such services include browsing an Internet website 212 adapted to provide specific information services on focused subject matter (such as information about the medical tests provided and associated conditions tested for) to members, Website-building services 214 to members, and topic-specific chat groups 218.

A third set of services, indicated by dashed line 210, comprises services which may be accessed via either computer- or non-computer-based modes of communication. These services include registering as a member of one of several privilege levels 211, ordering tests and other services 216, and reviewing data collected during tests 222.

Members are those users who have chosen to register with the system to allow them to access additional services (including secure data interchange) which are not provided to non-members. Registration to become a member may occur through telephone, fax or Internet access. Non-members are allowed certain access to information via the telephone, fax or Internet. Variation, in the type of access available between member and non-member services, as well as services available between web-type access and telephone or fax access, may be provided. That is, if a member does not register via the web, the member may not be provided with a web-access account. Members may be both individuals who order tests (such as physicians), and members who are to be tested (such as patients). Particular membership and user classes as pertaining to medical testing will be described in further detail below.

To allow for telephone and fax processing services 205, a telephone and facsimile call center sub-system 230, staffed with individuals who receive calls from individuals and members interested in accessing system services, is provided. The call center sub-system may comprise one or more human operators receiving telephone calls from users and inputting data into a data entry system, but may also comprise an automated data entry system. In one embodiment, the call center provides data entry to a database sub-system of the present invention to allow information to be entered by the telephone operator. The type of information entered depends upon the type of order being placed, and from or for whom the order is being taken. The call center can handle credit and debit funding verifications, and forward credit-verified orders to the database system of the present invention electronically.

Calls from individuals wishing to register as members are handled through call center 230 by “registering as a member” process 208. Calls from members who are authorized requestors wishing to order services are handled by “Authorized requestor ordering service” process 219 through call center 230.

A database sub-system 275 is used in the system of the present invention to store member data, non-member data, test data and other information. It may be maintained at the same physical site, or at a physically separate site, from the call center 230, or may be distributed between physically separate sites. Further details on the database system of the present invention will be described below. It will be recognized that the database system 275 handles all administration and management functions of the system of the present invention. Database system 275, in concert with call center 230 provides the authorization checking of decision block 103 (FIG. 1B) for non-web access to the system.

A web-hosting server 250 provides the backbone for the second type of service classes 210. The web server 250 must be configured for and have a means to interact with both the Internet, to allow for browsing of specific types of Internet news groups 255 provided in a conventional manner through a commercial Internet system administrator, and interface with data entry requirements of the database system 275 of the present invention, and interface with processes 208 and 219. As should be readily understood, appropriate security measures are implemented between the web server 250 and database system 275 to prevent unauthorized tampering of the database to ensure that those two sites interact. This can be accomplished with encrypted point-to-point SSL connections, certificate-based authentication, virtual private networks or combinations of these and other means. Web hosting server 250, together with database system 275 provides the authorization checking of decision block 103 (FIG. 1B).

As explained in connection with FIG. 1B, collected data is stored in database 275. Thus, authorized parties who are members of the system having an appropriate privilege level may view collected data and test results either through the call center 230 and process 207 (typically via return fax), or through web hosting server 250 and “Members reviewing tests” process 222. Access to collected data is through “Authorized viewing of collected data” process block 221, which insures that anyone requesting access to data is authorized to see that data.

The database sub-system 275 further interacts with a device management sub-system 240. In one embodiment, the device management sub-system 240 may comprise a separate database at the same or a physically separate location (such as a shipping provider) which tracks device specific data on each of the data collection devices utilized in accordance with the system of the present invention. As will be described in further detail below, each test device is uniquely identified and tracked through the various stages of the testing process from the point at which the device is ready for distribution to a user to the point when data is removed and the device refurbished for testing in a subsequent testing operation. In one embodiment, this occurs through the use of a unique, external serial number.

A logistics sub-system 260 is shown in communication with database 275 provides shipping services, which ensure that the devices are shipped to the location where the test is to be performed. The logistics system includes shipping, receiving, transfer, warehousing and other such services 217, and may be performed by a common courier service, with warehousing services, such as Federal Express® or UPS®.

Also shown is a receiving and testing sub-system 280. The receiving and testing system 280 accepts returning test devices, extracts test data and enters it into the database system 275. The receiving and testing system may comprise a contractor which receives devices which are returned, refurbishes the devices, and ensures that the data is extracted from the devices and entered into the database system.

Finally, a billing and accounting sub-system 290 may represent a financial database and/or accounting applications which ensure that orders tracked and implemented by the system of the present invention generate a revenue stream for the manager of the system of the present invention.

Example: Sleep Apnea Test Device Delivery System

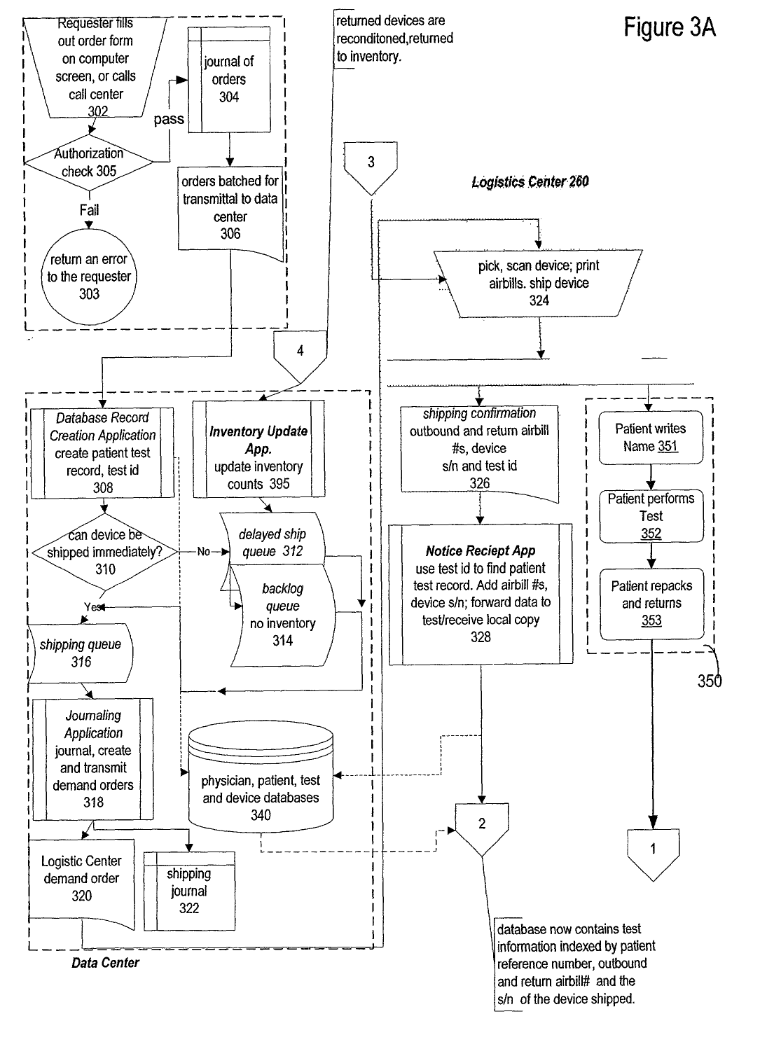

FIGS. 3A and 3B illustrate process and data flow for a specific embodiment of the method of the present invention wherein a sleep apnea test device is ordered and delivered to a patient. In the context of the following description, certain functions of the database and characteristics thereof will be described. An exemplary physical structure of the database will be described below with respect to FIG. 4.

In addition to database functions provided in the system, a number of data processing application programs will be discussed with reference to FIGS. 3A and 3B. Many of the programs relate to receiving messages and creating or updating database records assigning items to batch queues to be processed, taking items out of queues, and/or transmitting them to the shipping contractor or the refurbishing center contractor. In addition, applications for entering new devices into the database, editing the database to correct errors, running tests on devices, and updating the device records are described. There is also an additional application which examines test results and forwards reports to the correct medium (whether direct mail, fax, e-mail, or a secure web browser) to the requestor (a physician or patient). While it should be generally understood that the applications are functionally distinct, in reality the applications may be integrated into one or more applications as may be convenient during system programming.

It should also be generally noted, referring to FIGS. 1A, 1B and 2 from FIGS. 3A, 3B; the processes described in FIGS. 1A, 1B and 2 are logical processes. The steps described in the flows of FIGS. 3A and 3B describe an implementation of, but do not correspond one-to-one with, the logical processes of FIG. 2. FIGS. 3A, 3B ignore the specifics of web browsers, web servers and how information is displayed and exchanged between them. These details are well understood. Except where noted in FIGS. 3A, 3B with reference numbers from FIG. 2, the processes of FIG. 2 are implemented by steps in FIGS. 3A, 3B occurring at the data center. Embodiments of the present invention may have the data center steps all occurring at a single location, while other embodiments may have the data center steps occurring at physically separated locations.

The process begins at step 302 where a physician completes an order requesting a test. Orders are entered by telephone, or by a form submitted by fax, through the call center 230, or through the web hosting server 250 by filling out a form on a computer screen 204. Following step 302, the ordering and call center sub-system verifies that the physician is authorized to order services, and may also perform a credit check 305, before confirmation of the order. (Credit verification is not specifically required.) In one embodiment, following verification, an estimate of the initial ship date of the test device may be provided to the customer by querying an inventory of test devices and status maintained by system database 275.

Subsequent to the order authorization at step 305, the order may be added to an order journal 304. In one embodiment, orders are batched for processing at a data center physically separate from the call center at step 306. It should be recognized that real time processing of orders may be utilized and the batching process indicated at step 306 may be eliminated if real time communication between the system database and the order taking steps 302 and 305 is established. Alternatively, if step 302 occurs at a geographically separate call center, orders may be batched and transmitted periodically.

In the batch processing embodiment, orders may be entered into audit journal 304 located with the call center, with the database 275, or elsewhere. Once the orders are accepted, the system can verify previous orders via acknowledgments for orders entered, and can return inventory information to the order entry application to allow the shipping estimates described above to be provided. Such acknowledgments may be used to “check off” orders in the journal, and erase order information from the database at the call center or web input center.

A database record creation application 308 receives orders and creates database entry for each such order. Each such entry includes a unique test ID, and also includes a unique identifier of the patient. Data entered includes the patient's name, shipping address. In certain embodiments, patient financial information may be captured to bill the patient for the service. In addition, a requested arrival date may be placed in the system. The system first determines at step 310 whether the device can be shipped immediately. A check of an inventory count database 395 is made to determine whether inventory is available. If a specific arrival date is requested, the order is placed in the delayed ship queue 312, to be shipped to arrive on the requested day. If the device cannot be shipped immediately due to a lack of inventory, the order is placed in the backlog ship queue 314. If there is no delayed arrival date, or if the arrival date requested arrives and inventory is available, the order is advanced to the shipping queue 316. Although not specifically indicated in FIG. 3A, a shipping confirmation may be returned to the ordering and call center sub-system 230 so that the journal entry for that particular order may be marked, and the order information erased from the order/call center application database.

In one embodiment of the system, the logistics center 260 and receiving and testing sub-system 280 may be housed in one or more physically separate facilities from the call center sub-system facility 230, from database system 275 and web hosting server 250. In this instance, a journaling application 318 may be used which includes database 340 to remove a batch of orders from the shipping queue 316, and send them to the logistics center 260 via a secure network interface suitable for exchange of electronic data interchange (EDI) data between the data center and the logistics center 260. Connections may be made to the secure network using a variety of media, including dial-up or Internet connections. The data center and logistics center 260 need not have the same connection media, nor do they need to create a direct connection between them, although such connection is contemplated within the scope of the system of the present invention. In another embodiment, the logistics center 260 is located at the data center with the database 340 and shipping queue 316. The shipping queue is accessed by a simple query application. Devices are shipped from a small local inventory using a standard shipping application, such as Federal Express Ship It™, or a custom application.

Additional tasks performed by the journaling application 318 include creating a journal entry in a shipping journal 322 for transfer by the secure network, and copying requests to and from the secure network for any traffic from the logistics center 260. In one embodiment, when the logistics center 260 receives an order, it will return a receipt acknowledgment of the order to the database 340. If such an acknowledgment is received, journal entries in the shipping journal 322 may be removed. Generation of the demand order 320 to the logistics center 260 is also handled by the journaling application 318.

Once the demand order 320 is transferred to the logistics center 260, at step 324, a sleep test device is selected for shipment. Device specific information is recorded to associate the selected collection device with a patient, air or other types of waybills are printed, and the device is shipped to the patient.

At the logistics center the device may be readied to ship by a shipping clerk who retrieves order information on a computer screen, selects a data collection device from the inventory, scans a bar-coded serial number from the outside of the device's sealed shipping box, and prints waybills. One of the waybills is addressed to the patient for shipping the device out; the second is addressed back to the logistics center for the return of the device. The two waybill numbers are recorded with the test identifier in the database 340, to facilitate identification of the proper patient when the device is returned. Each waybill includes a test ID as the tracking number and the device serial number. The box may also contain a piece of packing tape with which the patient may seal the box for returning to the test administrator following the study. A test device is selected from a pool of identical devices in a warehouse just prior to shipping in order to keep costs down. To facilitate this, the serial number is recorded electronically internal to the test device, and is also noted on a bar-coded label on the outside of the box. When a device is shipped to a particular patient, the waybills are printed with the patient's address and the test I.D., the device is selected and its serial number scanned and recorded with the patient and test I.D. This system of recordation, along with the waybill number and expected return time, ensures that the correct patient can be associated with the collected data after the test is completed. The steps involved in receiving a returned test device ensure that the correct serial number is recorded on the shipping box prior to placing the box in the warehouse.

Two processing sequences occur following actual shipping of the device at step 324. First, at step 350, the patient will receive the collection device and will perform the test 350 in accordance with the instructions provided with the data collection device, instructions from the ordering physician, or from the system administrator.

Secondly, at step 326 a shipping confirmation, which may include outbound and return airbill numbers, a device serial number, and a test identifier, will be returned to the data center and database 340. The serial number is recorded with the test record in 225, also the test I.D. may be recorded in 240 with the device record. Once the shipping confirmation 326 is received, a notice receipt and update application 328 is invoked at the data center to add new information, such as waybill number, ship date and serial number, to the record for this test in the patient, test and device database 340. In addition, it removes the shipping request from the transaction journal 322.

The notice of receipt and update application 328 also identifies the test record as having a test which is expected to be returned within a certain period of time. The period of time may be set at any number of days, but for a sleep apnea test the number of days is ten. In one embodiment, the application 328 further sends information about the test (such as the device serial number, ship date, expected return waybill number and date, and test identifier) to the receiving and testing center 280 in FIG. 3B. In one embodiment, the receiving and testing center 280 includes a separate, partial copy 368 of the database 340 (FIG. 3B), which receives (via connector 2a) the copy of the aforementioned information. Another embodiment allows receiving and testing center 280 to access the central database 340 directly to access test information and insert collected data.

In one embodiment, physical test fixtures which couple to the returned data collection devices are used at the receiving and testing center to process returned data collection devices. The function of such units is described below, but at present it should be noted that a replicated database may be shared by all such test fixtures at the receiving and testing center, or replicated at each test fixture individually. If a standard commercial replicated database package is used, it will have its own mechanisms for replicating information which are scheduled to run periodically. If there is no replicated database, the same information may be extracted from the data management system and sent to the testing and receiving sub-system location (e.g. to the shared server or to each diagnostic unit), in a standard, searchable form, by application 328.

Returning to FIG. 3A, at step sequence 350, once a box is shipped to the patient, the patient will unpack the box, write his or her name on a paper label affixed to the front of the device (35), and perform the study or test 350 which data collection device is designed to perform. This test may take several days and following the test, the patient will then put the device back in the box, seal it and use the return waybill to ship the box back 353 through the logistics system 260 to receiving and testing station 280. (It should be recognized that the patient's name is all that is necessary to track the test).

Following connector 1 from FIG. 3A to FIG. 3B, at the logistics center at step 352, the returned device is received, the waybill number and the serial number on the box is recorded, and the box along with the waybill forwarded to the receiving and testing center 280.

Following the transfer of the package from the logistics center 260 to the receiving and testing center 280, at step 354 the return airbill is recorded, and the returned data collection device is removed from its shipping box and connected to the test fixture. The test fixture will check the basic operation of the device at step 356, and extract the internally recorded serial number and data (sleep log) from the device. During the extraction step, the test fixture, which may comprise a personal computer with appropriate peripheral connections for a scanner and the test device, will read the serial number of the device and extract the sleep log from, for example, non-volatile memory and the test device. The serial number is stored in the file within the sleep log and is used to locate the device record in data management database 240. In one embodiment, a local copy 368 of data management database 240 is used, having been loaded with the correct device data by step 328. In another embodiment, step 356 accesses the master copy of the device management database 240 at the data center through a suitable data connection. In addition, the test fixture will erase the log memory and run a diagnostic to ensure that the device is functioning properly. The results of the diagnostic test may be permanently logged for documentation for entities such as the Food and Drug Administration (FDA).

Following the diagnostic, the test fixture, in step 356, will use the airbill number and serial number to locate the test record in 368 (for some embodiments) or directly in 340, 275 (for other embodiments). In decision box 350, checks are made to determine if the returned device contains data for the correct patient. In one embodiment, this check includes verifying that the test identifier in the device record, and the waybill locate the same test record. In an embodiment, the expected return date in the test record may also be checked to verify that the device is being returned when expected. An embodiment may further ask the technician operating the test fixture to verify that the name which the patient wrote on the paper label fixed to the data collection device (step 350) is the same name recorded in the test record. If the checks in decision box 350 pass, then there is a reasonable assurance that the sleep log for the correct patient has been found. If the checks at decision box 350 fail, a flag indicating that this test is invalid is placed in the test record in the database, and manual recovery is initiated.

If all the checks in decision box 350 pass, the patient record is updated with the sleep log at step 364, and an indication is made that all checks were passed. At step 364, for one embodiment, this information will be used to update the local copy of the patient test data base 368 with the actual return date, the collected data, and specific information about the condition and operability of the returned device (whether the device was returned to inventory). The application 366, together with step 374, then synchronizes the local copy 368 with the master database at the data center (340, 275). In another embodiment, these updates are made directly to the master database 340, 275, through a suitable data communications connection.

Because there is no guarantee that the box used to ship the device originally will be the box used to ship the device back, the waybill number must accompany the device box to the testing and receiving center facility 280. In addition, the internally recorded serial number is used, not the bar-coded serial number on the box, as a verification that the correct test has been received. This provides an additional check on the testing procedure.

At step 362 if either the device or patient record does not exist in the local copy of the database 368, or in the master database 340, 275, or an error was flagged earlier on either the device or test record, there may be ambiguity as to which patient and test this particular test belongs to. Procedures may then be deployed for resolving such errors.

Moreover, if the study period does not correlate with the waybill dates, then the device may have failed or the tracking process at the logistics carrier may have failed. If the outgoing waybill number does not correlate with this test, then the patient or health care provider may have more than one study occurring. They may have put the device in the wrong box. Each of these particular possibilities can be dealt with on an individualized basis.

In one embodiment, when the patient's test record is updated with a sleep log, the test record is placed into the queue at step 336 to be examined by a medical technician. At step 338, a medical technician can be provided with a display of the sleep report and perhaps an automated recommendation based on known factors which may result from characteristic compositions of known data points within the test parameters. For example, certain combinations of parameters may yield specific indicators pointing to a general conclusion for each combination. The technician is then allowed to select one of several form letters to be sent to the patient and the data management system may personalize it by inserting a name and address as needed. A report generation application 340 then allows the report to be generated and forwarded to the patient and/or physician through any number of different testing phases. In one embodiment, a form letter is chosen automatically when the log is analyzed, based on the results (e.g., the test was inconclusive, the test indicates that the patient has a problem, etc). Another embodiment may use the same queue 336 and evaluation step 338 for assuring the quality of the diagnostic testing service.

In one embodiment, queue 336 and step 338 are not performed, and step 340 generates the proper reports, storing them in the test record in database 340. These reports are available to authorized requestors through checks of process 221, and through call center 230's fax capabilities, or web hosting server 250.

At this point, distribution and retrieval of the test has been completed at step 398.

Again returning to step 354, the testing and receiving center includes facilities for refurbishing test devices once they return to the testing and receiving sub-system. As shown at step 370, once a returned device has been diagnosed and the sleep log extracted, a refurbishing step 370 occurs. At this step, physical components of the device which are not reusable for sanitary or other reasons are replaced. The internally recorded serial number is used to print a new label for the data collection device's shipping box, the device packed in a new box and the new serial number label affixed. Subsequently, at step 370, the returned device is boxed and returned to the logistics center inventory at step 372. Following connector 4 from FIG. 3B to FIG. 3A, an inventory update application 395 at the data center updates inventory counts in the delayed ship queue and backlog 312 and 314, the function of which is previously described.

FIG. 4 represents a graphical depiction of the data structure in an exemplary database 340, and 275, 240, used in accordance with the present invention. Referring to FIG. 4, device management 240, comprising three tables, corresponds to device management 240 of FIG. 2. The remaining items in FIG. 4 correspond to database system 275 of FIG. 2. Collectively, the items in FIG. 4 correspond to database 340 of FIGS. 3A, 3B.

Database system 275 is, in one embodiment, housed at a physically separate location than the web system administrator or the call center local administration. Beginning at a point when a particular user decides to arrange for a test to be provided, a file must be maintained of the test where information may accumulate until it is reported to the user. This data management system is required for maintaining all such patient records since there is a large amount of records open at any one given time. As the test system progresses, information will be added to the record and the data management system quickly locates the patient record and a given number of related pieces of information are added to it. Within the constraints of the process flow, in one embodiment of the invention, the system uses a batch transaction model between locations of physically separate entities.

As shown in FIG. 4, the database will comprise a set of tables comprising what is collectively referred to herein as a physician database 335, at least one table 550 collectively referred to as the patient database 560, an additional set of tables 350 which represent specific tests data collection services. In the current embodiment, this table contains one row or record for each medical diagnostic test ordered. In the current embodiment, the consumer questionnaire data table 365 contains data provided by members describing their sleep experience.

In one embodiment, the tables represented in the physician database include a clinics table 912, an accounts table 914, a credit table 916, and a physician data table 540. The physician data table 540 serves as the master data table for the physician database and includes identifications of the specific member data ID (IMD_ID), whether the physician is associated with a specific clinic (ICLINIC), items such as the first name, last name, middle initial, phone number, fax number, e-mail, specialty, specific doctor ID flags, provider ID's, account ID's, additional notes, and an alternative address data field. The clinic pointer will identify a specific clinic (ICLINIC) within the clinic's data table 912. Again, information such as name, phone number, fax and specialty, etc. will be provided in the data table 912. The physician's accounts data table 914 links directly to both the clinics table and the physicians table 540, and provides reference information to accounting personnel at the physician's office including the physician's ID account, contact names, phones, credit ID's, and the physician's clinic reference. Table 540 also contains authentication information, including username and password (encrypted) for authenticating the identity of a physician requestor. In the current embodiment, all physicians contained in table 540 enjoy the privileges of “physician” membership level. In another embodiment, different privilege levels may be encoded in table 540, for example referral privileges allowing a physician to refer patients and review the test results for referred patients.

The credit data table 916 contains credit card data information should the physician decide to pay for testing using a credit card, and can include credit information such as the account type, expiration, first and last name and billing information, as should be readily understood from an examination of the data table 916 in FIG. 4.

In the current embodiment, the patient info database comprises patient table 560, and includes data such as the first name, last name, a unique identification number (IREFNUM). In addition to contact information data, the table the patient's current physician (IMD_ID).

Information in the patient table 560 may be referenced by the consumer-level questionnaire data table 365. The consumer-level questionnaire data table 365 includes a unique identifier (quest_id), a reference number (IREFNUM) referring to a patient in table 560.

Device management 240 for an embodiment of the present invention comprises a device data table 952, a manufacturing lot data table 954, and a maintenance data table 956. The device data table includes information indexed on the unique serial number (ISERNUM) of the specific data collection device. For each device, a lot identifier, manufacturing date, the current hardware and software present in the device, and the unique identifier of a test (iCurr_TestID) referencing a record in test table 550.

The manufacturing lot identifier (iLot_id) references a separate table (mfg_lot, 954) indexed by manufacturing lot number. Table 954 records all information common to each manufacturing lot, including where individual components originated; over what time period devices in each lot were manufactured; the introduction date; the original hardware and software revisions; the current testing plan software revision (CTEST_PLAN) present in the device; and the serial number of the first device in this lot.

Finally, the maintenance data table 956 is linked through the serial number of the device (ISERNUM) to the device data table, and describes each and every thing which happens to that data collection device. Such information includes for a date an operation was performed on the device (DDAT); the current hardware (CCUR_HW); the current software (CCUR_SW); whether hardware and software for the particular device was updated during the operation (CCNEWHW and CCNEWSW); the current operational status (COPEN_STATUS), testing plan which defines the last diagnostic operation performed on the device; and any notes provided by the test technician. Table 956 also records all items packed with the device and used in testing the patient, including sensors, cables, plastic items, manuals. Database 240 also comprises a device history file which is required by the United States Food & Drug Administration (FDA).

Other embodiments of the present inventions, for other kinds of data collection devices, will record different maintenance information, or may combine the function of maintenance table 956 with another table, such as test table 550.

Test data table 550 in the current embodiment describes each test performed using a data collection device. It is intended that one instance of this table, or a similar one, be provided for each service that an authorized requestor has ordered through the present invention. In the current embodiment, a record is created in table 550 when a test is ordered, as described in application step 308 of FIG. 3A. The record includes substantially all of the information in the patient table 560 for the patient being tested, as well as a reference to the physician ordering the test. Step 328 adds the shipping information and serial number of the collection device shipped for the test. (This completes cross-referencing of Tables 550 and 952.) Step 356 of FIG. 3B adds a copy of the collected data to the record of table 550 located by searching table 550 for the returned device's serial number. The check described for decision box 350 involves verifying that the unique record of table 952 returned when searching for the returned device's serial number, references a test identifier which in turn locates a test record in table 550, which itself contains the same device serial number as the returned device. Further, this test record must also contain the same waybill as was recorded in step 354, and the patient name in this record of table 550 must be the same as the name written on the device by the patient.

Data table 550 includes, for each test device, a test identifier (ITEST_IDENT); a unique identifier of the patient being tested (IREFNUM); the order date (DORDER_DATE). The record also contains the patient's first name, last name, middle initial, phone, day phone, fax, e-mail, a unique identifier for the patient's physician, serial number of the data collection device shipped to the patient, patient's address, and any applicable data flags. Further, the table 550 contains the dates when the test was ordered, the outbound waybill number was provided (COUTBOUNDAWB), the ship date (DSHIP_DAT), the return waybill number (CRETURNAWB), the date of expected return (DEXPECTEDRET), the actual return date (DACTUALRETDAT), and, as noted above, serial number and account ID information (ISERNUM/1; IACCTID/1). Some embodiments may also contain an account ID number, credit information.

In one embodiment, the test table 550 includes a copy of the test log from the retrieved from device. In another embodiment, test table 550 also includes summarized test result data. In a third embodiment, the test log retrieved from the device, along with any summarization or analysis of the test log, is included in a separate table related to the test table by the test identifier TEST_IDENT.

The patient, physician and test databases represent the relationship among patients and physicians and test records of each patient's test history. As additional services are expanded, additional tables may be added similar to the test table 550 shown in FIG. 4. Additional tables will be linked to the patient and physician tables as needed.

Logically, a record in test table 550 which tracks tests has information within it which is current at the time the test is ordered. The physician 540 and patient 560 databases contain information which is maintained up to date for active members by those members editing their profiles.

In sharing information between the diagnostic software used by a technician at the receiving and testing 280 and the data center, information is extracted from each individual database as needed and, for one embodiment as set forth above is copied to a separate read-only table and transferred to the remote location where devices are returned and received. In one embodiment, this information is accessible through an OBDC driver, such as the Microsoft OBDC driver. In another embodiment, another database access technique such as JDBC is used. Similarly, records in the device table 952 corresponding to devices in tests expected to be returned may be extracted from the device table 952 and transferred to the remote test location.

The diagnostic program at the remote location can use the information to verify the identity of the patient whose test has been returned. Maintenance records shown in FIG. 4 are created for the diagnostic operations performed on the device and appended to a maintenance table indexed by device serial number along with flags and text from all fields. Each night, or at some other regular interval, for one embodiment, the maintenance and test result tables are transferred to the device and the patient, physician and test databases, respectively, and appended to the corresponding tables as shown in FIG. 4. For another embodiment, those maintenance records are appended directly to the master device management database 260 using a suitable data communications means.

Virtual Test Lab

The system of the present invention, including the components shown in FIG. 2 and FIG. 4, allows for the provision of a “Virtual Test Lab.” This concept transfers the traditional real world test lab—in one embodiment a sleep testing lab—and moves it to virtual space.

In particular, the virtual test lab is a system and process by which a patient may be referred to a specialist for diagnosis and treatment. The treatment may be referred to the member by a member- or non-member physician. This referral is generally made by a primary care physician, but contemplates direct patient-to-specialist contact. The virtual test lab facilitates this diagnosis and treatment by allowing a physician who is a specialist in the particular area of concern to have the opportunity to browse referrals, decide whether to proceed with the test or not, and order tests for patients. The system provides total confidentiality of patient identity, medical data, and test results. The specialist can control which test referrals he or she may accept, the patients they wish to request tests for, and the number of tests they may interpret via the system.

In one embodiment, the virtual test lab is provided by processes 223 and 224 within box 225. The primary care physician can enter referrals into the system directly from the web through “Refer patients for testing” process 223. The specialist can later enter the system and browse the referrals through “Approve referrals” process 223, choosing to accept or reject each of the referrals as a group or one at a time. If a specialist accepts the referral, an order will be entered through process 219, and a data collection device will be shipped to the patient. The collected data may then be analyzed by the specialist and optionally forwarded to the referring primary care physician.

In one embodiment, the member physician can provide limited privileges to the non-member referring physician, in web hosting server 250 and database system 275, to view results of tests for referred patients through the test review process 222, or through call center 230 and fax 202.

As described herein, the system of the present invention will be presented as a virtual test lab with a specific implementation for providing a medical test device to patients at the patient's home, including shipping the data collection device, tracking the device, retrieving the device, extracting the collected data, and distributing the data to an authorized physician and registered patient. The particular medical testing described will be that of a data collection device suitable for use in testing sleep apnea. Hence, in this embodiment the data collection device is transferred to a patient's home, the patient uses the device for several nights of sleep, at which point the device will contain a sleep log comprising the patient's sleep data useful in diagnosing whether the patient suffers from sleep apnea.

Use Classes

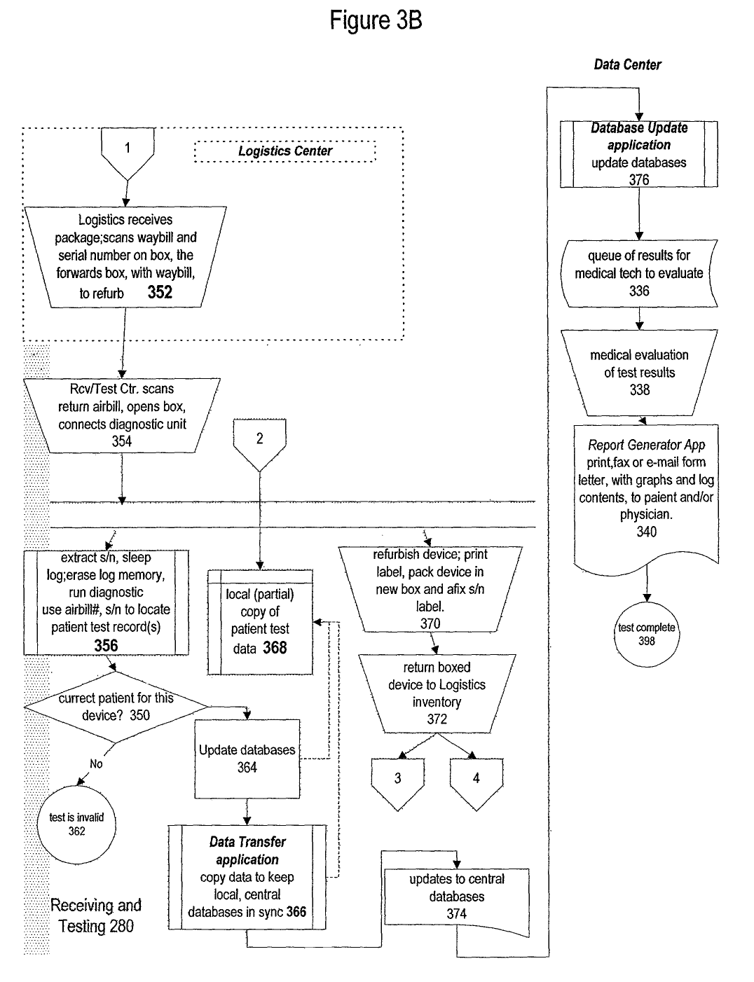

In accordance with the aforementioned embodiment, several levels of users are defined in the system of the present invention. FIGS. 5, 6, 7, and 8 are industry-standard Use Case diagrams specifying what ways each level of user may interact, in one embodiment, with the system of the present invention.

Non-Members

Non-members include anyone in the general public who may wish to access specific information on the medical conditions the system administrator offers diagnostic services for, data about services, via the telephone or the World Wide Web. The ways in which a non-member may interact with the system are illustrated in FIG. 5. In the present embodiment, the non-member can view specific information concerning sleep apnea 502 (symptoms, causes, treatment alternatives, etc.), complete a questionnaire 504, or request information from the system administrator. A request for information may result in a request to mail information to the consumer via an information mailing action 525, on e-mail information via SMTP protocol 530. Likewise, non-members may further invite a friend 508 to join or visit the system's web server, or communicate directly with the system operator 510. This may be implemented by an e-mail form on the website or a mail to user and SMTP protocol 530. The non-member may use a find-a-physician service 512 which requires access 535 to a physician locator database 535 of physicians who have registered with the system and made themselves available for this service.

In addition, the non-member may choose to register or log in as a member. At member login, access to a member authentication database 545 is required. Finally, the non-member may register or log in as a physician member 515 requiring access to a physician authentication database 555.

As noted above, members are those individuals who have chosen to provide specific information about themselves and identify themselves in a system database in the system of the present invention. Registration allows members to access services which are available only to members. Privileges of various levels may be provided to members through a members-only website or via members-only functions available through the call center sub-system.

Members

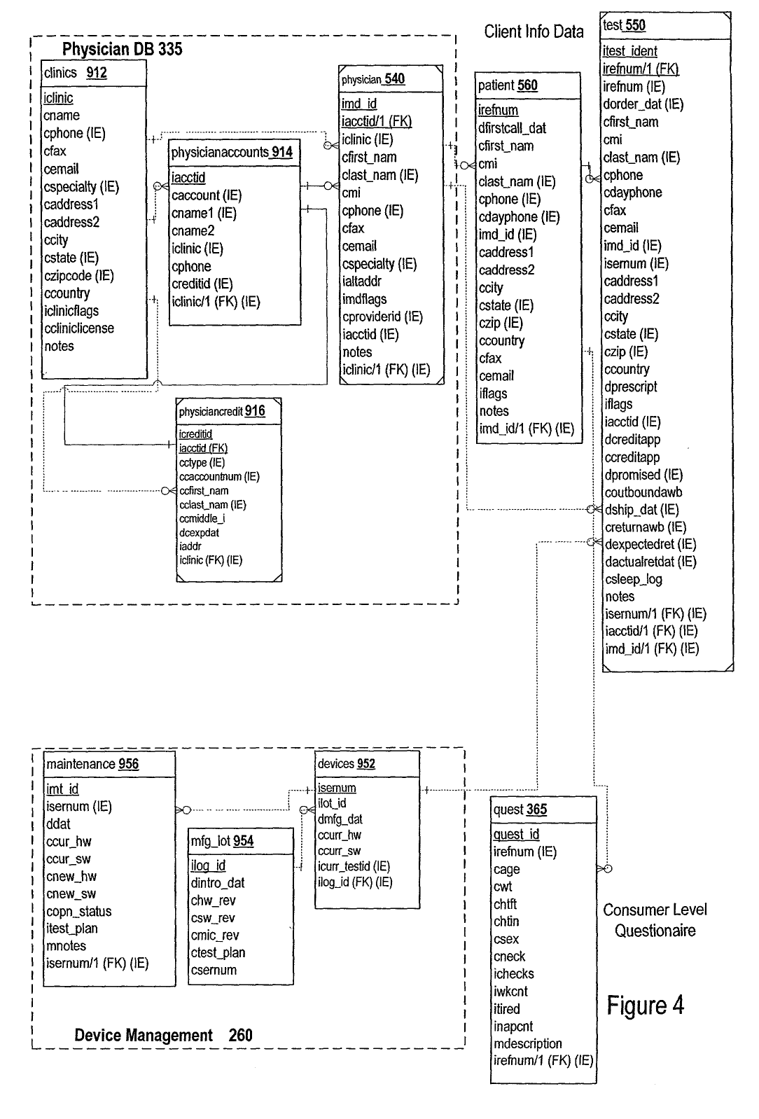

Members-only access to particular functions is illustrated in FIG. 6. FIG. 6 shows uses of the system available to members who are not physicians. As shown therein, a member has full access to all of the consumer use cases 500 shown in FIG. 5. In addition, the member may login 605 and edit their profile 604, resulting in an interaction with the member database 545. In one embodiment, members may edit their profile to allow member physicians (or non-member physicians with privileges granted through the virtual test lab) to view their test results. The member may log out of the system 606, indicating to the system that no further privileged access may be made by this user until another login 605 is completed and may also access treatment-specific chat groups, such as sleep apnea chat groups, 610. Access to the sleep apnea newsgroups 610 may be maintained by the system administrator, or the system administrator may simply facilitate access to such chat rooms or newsgroups. If the system administrator does not maintain the newsgroups, the member is referred to an external chat group or news group host 620. Chat rooms may be hosted by the system administrator, or the system administrator may track who enters the chat room through the web hosting server portal as part of a service of providing additional servers and user-specific information for the members accessing the system.

Members generally fall into two categories: physicians and patients. Physicians can further be divided into specialist physicians and referring physicians. Physician members are the only members who can legally initiate a medical test. Registering as a physician requires completion of a number of verification processes. Verification is designed to ensure that a physician is licensed and requires the provision of specific information which allows the system administrator to verify the physician's license and standing to legally order medical tests. Only when verification is completed successfully is a physician admitted to this user class. After registering, but before verification is complete, a physician may request services, but those services will not be delivered until after verification is accomplished. All physicians must be members to access physicians-only services, either via the website or via telephone.

Physicians

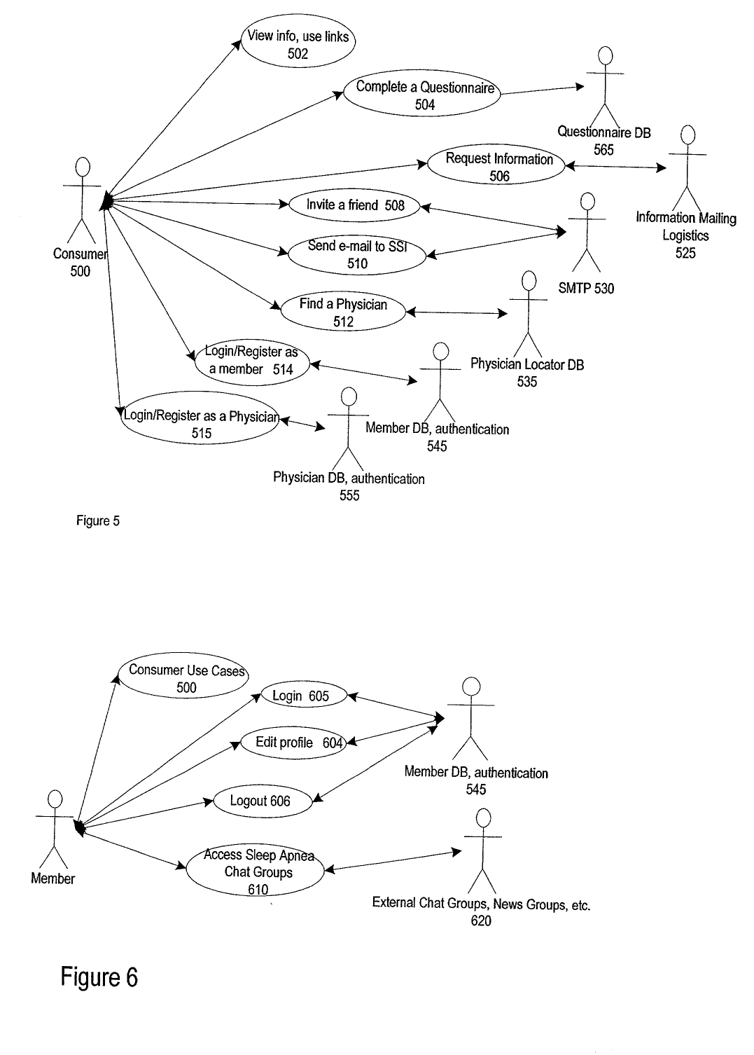

Privileged access to the current embodiment of the system of the present invention available to physician members is illustrated in the use cases of FIG. 7. As noted therein, a physician member has access to all consumer use cases which are represented in FIG. 5 (500), and all member use cases illustrated in FIG. 6 (600).

In addition, physicians may login (706), edit their own registration profile 707 and in doing so, interact with the physician database 555. Physician members may logout (708), indicating to the system that no further privileged access may be made until another login 706 is completed. Further, the physician can invite additional users to the system, including inviting a patient or consumer 708 or inviting a colleague 710. Doing so will invoke simple mail transfer protocol (SMTP) 730 as discussed above. An additional service provided to a physician is to create a link 714 to the physician's own website.

The physician has access to test report delivery and administrative functions, such as having test results forwarded at 716 via e-mail (including secure e-mail) again using SMTP 730. The physician is allowed to query certain test and patient information in the test records 750, by querying a patient's test records 718, querying the status of a test 720, or approving referring physicians' tests 722 if the patient has provided a medical release. Yet another option allows a physician to order a test 724 or locate or create a new patient 726 which includes interaction with a patient table database 760. A referring physician 700a may refer a patient for testing 728. The member physician 700 must approve the referring physician's test 722, before the system of the present invention will invoke its ordering functions. The virtual sleep lab described earlier is described by use cases 728 and 722.

Physicians who are members are also provided with an option of being displayed by a “find physician” service. Physicians must give explicit permission, by editing their profile 707 before their identity is released to anyone seeking a local physician.

In addition, member physicians may have the opportunity to access additional services 780 provided by the system administrator including: access to detailed information about sleep apnea tests and devices available through the service of the present invention, tutorials or classes for credit on sleep apnea 781, instructions in how to interpret test reports, and other information. Member physicians may further be provided with the option of building their own website 714 within the system administrator's website.

Still further, the member physician may be provided with the ability to host a virtual sleep lab within their own website, allowing users to access the information of the system administrator via the physician's website.

With respect to reviewing test results, a physician may be provided with various ways to select and view patient tests, such as selecting tests which have not yet been reviewed 723, with the system filtering tests by the physician's identity (that is, only tests ordered by that physician are selected for display), and the physician may select a specific test by patient personal information 720. The physician can provide some combination of name, e-mail address, approximate test date or other personal information for the patient in a query form or to an operator at the call center sub-system, and the system will attempt to locate the unique patient matching all the criteria listed. Alternatively, if the selection cannot locate a unique patient, all matching patients may be listed and the physician may choose the specific patient he wants or provide additional criteria to narrow the search. Once again, the physician's identity implicitly limits the search data so that the only tests returned are for patients who have explicitly released their medical records to the requesting physician by, for example, editing their member profile 604. In one embodiment of the present invention, these queries return data from the database table containing test information (750).

It should be particularly noted that unless a patient has specifically released their medical records to a requesting physician, those records are not visible to that physician. Even though the physician may be the most recent physician to order a test for the patient, the physician will only see items they ordered, unless the patient releases information to them. Releasing data to the current physician is done by checking the medical release box on the patient or member's profile 604. The authorization policy for viewing collected data, and checking for authorization, is performed by process block 221 of FIG. 2. As an example, consider a patient X who begins with a physician A. Physician A receives the sleep questionnaire. Then patient X goes to physician B who orders a sleep test. Then patient X goes to physician C who reviews the test and recommends treatment. If the patient has edited their profile and checked the box to release medical information to the current physician, physician C may see the entire history, physician B may only see the sleep test results, and physician A may only see the questionnaire. If patient X does not check the medical release box, then physician C may not see any of the patient's records. If C orders a test for X, then C may review the result of the test only until the patient checks the release box. Member physicians may provide primary care physician access to patient results by faxing or mailing reports, or in another embodiment, through a login and limited privileges via the member's website. Another embodiment may be report via secure e-mail.

In addition, a physician will be offered the opportunity to be listed in the system administrator's “find a physician” directory. Those who provide such explicit permission, by editing their profile 707, will have the contact information displayed when a consumer asks for a physician in the physician's area. This service may be accessed through the Internet 204 or through the call center 230. Such a service will, for example, search on postal zip code and/or telephone area code.

Referring Physician

A referring physician refers patients to member physicians (who are specialists) for testing. A referring physician is not a member and may not tracked by all embodiments of the system of the present invention. In another embodiment, referring physicians' information may be tracked by the system of the present invention, and limited privileges provided to them. In another embodiment, “membership” to a physician's virtual test lab may be managed on behalf of the member physician, allowing the physician to provide his/her referral network with their own password access to his virtual test lab. When a member physician orders a test for a referring physician's patient, the referring physician generally need not be sent a confirming e-mail. However, notification mechanisms for referring physicians may be implemented.

Patient Members

Patients are individuals for whom a medical test has been ordered. Patient records in the system are “created” by a physician and associated with that physician in use case 726, usually as a side affect of ordering a test 724. For each patient, one or more tests, surveys, or data collection mechanisms may exist, and other information may be created. A user who registers as a member (FIG. 6), and who later has a test ordered for them becomes a patient through use case 726. His or her member profile acquires the privileges of a patient member in this way.

For example, a physician may order a sleep test with the system of the present invention, retrieve the results, then perform an outpatient corrective procedure in his office. Through the system the physician may order a follow-up test to assess the effectiveness of the procedure. In this case the physician will want to review the “before and after results” to assess the effectiveness of the procedure. The system administrator can, in such cases, provide additional information and procedural services, such as sleep apnea questionnaires, health assessment surveys, or other tests. Each instance of these services must be separate and associated with one patient and at least one physician. (Tests and procedures may be associated with more than one physician, such as the patient's primary care physician and the specialist who ordered the test, or with specialists of differing descriptions (such as a sleep specialist and a cardiologist)).

Disclosed patients are members who have allowed a medical release of their current information to their current physician. In requesting this service, the member must provide the physician's name, address and telephone number. In one aspect, the system administrator may forward the patient demographic and medical information to the physician with a cover letter. If the physician is a member, the patient record will be linked to the physician's by an identifier placed in the patient database record for the physician. Only disclosed patient records may be released to the current physician. If the patient has not also explicitly registered as a member, the patient cannot release their records and the requesting physician can only see the results of the test he or she ordered. To facilitate the registration process, registration may take the form of provision of a faxed medical release which provides access to designated physicians.

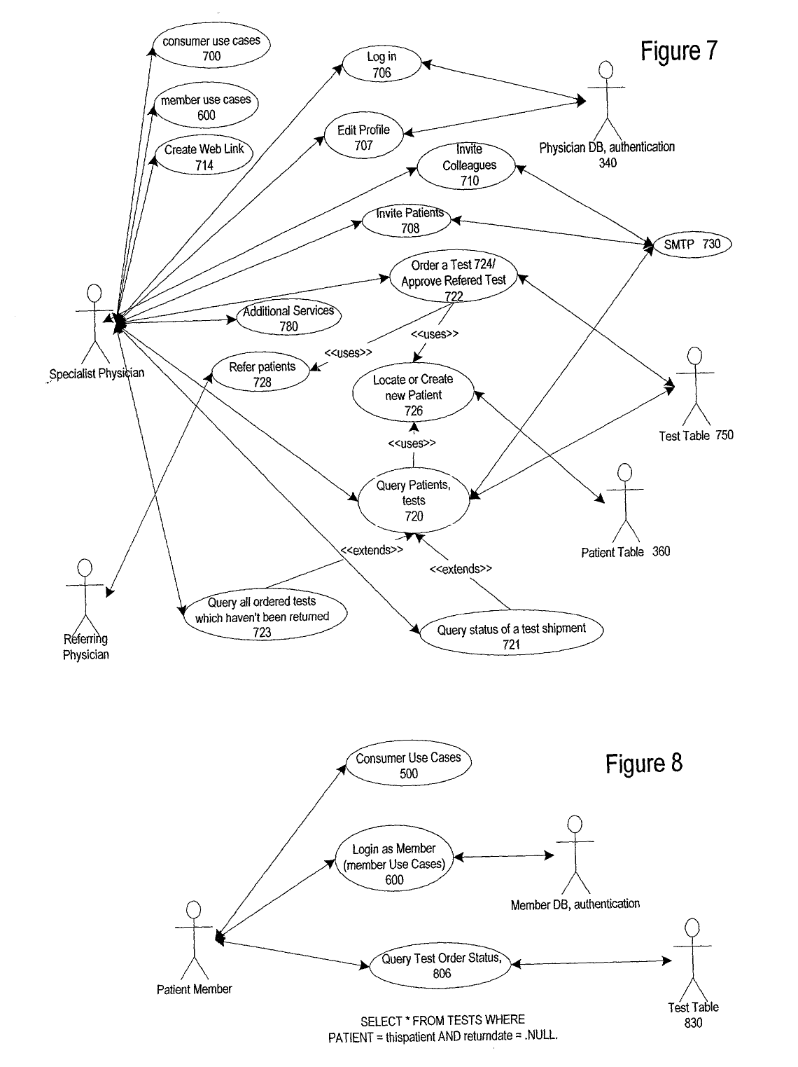

When a physician orders a test for a patient, and includes the patient's e-mail address, the patient will be sent a message confirming the test and the expected delivery date. The confirmation will include an invitation for the patient to become a member. If the patient is already a member as shown in FIG. 8, the patient has the ability to query test status 806, which interacts with the test table 750. In one embodiment, the patient may query the status of the test through web-access only, using a test confirmation number included in the confirmation e-mail. In a further embodiment, the patient may be allowed to review their test results and receive physician feedback via the site.

Virtual Test Lab—Physician Site

When a member physician creates a website or links a website to the system of the present invention, he or she may create a virtual test lab, as a page on their website. This allows the member physician to appear to his referring physicians as a sleep testing lab. Physicians may refer patients to the member physician through the virtual test lab page. The member physician can use the system of the present invention to administer the test, interpret the test results, and provide the test results back to the referring physician.

A virtual test lab page may be a variant of the form used by the member physicians to order tests in the embodiment shown in FIG. 2, process blocks 219. The virtual test lab form on the physician site, through process block 223 of FIG. 2, interacts with the system database 275 in a way that parallels the member physician's order entry process. The Universal Resource Locator (URL) to the virtual test lab page may be published on the physician's web page if he or she so desires. Alternatively, the member physician may choose to provide the URL only to physicians that he or she has agreed to take referrals from. As the member physician is financially responsible for all tests approved by him or through her virtual test lab, this makes it more difficult for the site to be compromised or for patients to order their own tests by entering their physician's name.

The many features and advantages of the present invention will be apparent to one of average skill in the art. All such features and advantages are intended to be within the scope of the invention as described herein by the written description and figures, and as defined by the following claims.

In the present invention, the ordering call center sub-systems, local data system sub-system 240, logistics sub-system 260, and the receiving and testing sub-system 280, are contemplated as being physically separate from each other. However, all physical combinations and sub-combinations of the physical arrangement of the system are contemplated. For example, all sub-systems may be housed at a single facility. Alternatively, the logistics sub-system 260 may incorporate the receiving and testing sub-system 280; the database system, and ordering and call center sub-systems may be combined in a centralized data center and so on.

The logistics center shown in FIG. 2 may comprise, for example, a Federal Express® hub, and services may be contracted out to Federal Express® and/or UPS®. Certain interactions must occur between the logistics hub and the data system, including the issuance of a demand order to the logistics center, an acknowledgment of the demand order and a ship acknowledgment, an acknowledgment when a test device is returned from the user to the logistics center, and a testing routine wherein, if the device is not returned by the expected date, action is taken on the part of the logistics center and/or the data management system to retrieve the device.

If logistics center 260 comprises a Federal Express® hub, the data system and the communications infrastructure of the system of the present invention must be adapted to communicate with the logistics environment. Since an interface between the system of the present invention and the logistics center can be easily implemented on a batch-oriented electronic data interchange (EDI) transaction model, all communications may likewise be oriented around a batch model. However, if the logistics center 260 can accept real time transactional data in the EDI model or a separate model, a full-time connectivity and real time transaction data passage can be implemented in accordance with the system.

Electronic data interchange format through Fed Ex Net (Federal Express® value added network) is at least one particular format for interacting with the logistics system in accordance with the present invention. Test devices in accordance with the present invention may be kept in inventory at the logistics center hub sealed in boxes and ready to ship. The logistics center can receive demand orders electronically from the database system 275 and can reply with a confirmation or shipment and actual waybill numbers and device serial numbers. This is generally accomplished using standard EDI transactions.

In one embodiment, the receiving and testing sub-system 280 may be housed within the Federal Express® hub or logistics center hub itself, or may be a separate physical facility from the hub. This may be handled by an outside contractor when necessary. The work done at the receiving and testing sub-system 280 will be specific to the particular device. As noted above, equipment and software necessary for performing a cleaning and testing function on particular devices is adapted for each test device.

The many features and advantages of the system of the present invention will be apparent to one of average skill in the art. All such features and advantages are intended to be within the scope of the invention as defined by the written description and drawings presented herein, and in accordance with the following claims.

What is claimed is:

1. A method for securely collecting information from a user, comprising:
(a) delivering a medical test device to a patient;
(b) retrieving test data from the test device; and
(c) distributing test data to authorized recipient.

2. The method of claim 1 wherein the data collector is a hardware device.

3. The method of claim 1 wherein said step (b) comprises retrieving the data collector and extracting the data.

4. The method of claim 1 wherein said step (b) comprises extracting the data before retrieving the data collector.

5. The method of claim 1 wherein said step (a) comprises:
(a1) accepting a request to ship a test device from a requestor; and
(a2) communicating with a logistics system directing shipment of the device to the patient.

6. The method of claim 5 wherein said step (a1) comprises the sub-steps of:
authorizing the requestor to make the request; and
accepting the request.

7. The method of claim 1 wherein said step (a) includes the sub-step of: providing an id number for the medical test device; and
recording the id number prior to transmitting the test device to the patient.

8. The method of claim 1 wherein said step (a) comprises:
(a1) authorizing a requestor to make a request to transmit the test device to the patient;
(a2) accepting a request from the requestor to transmit the test device to the patient;
(a3) recording a unique identification number for the test device; and
(a4) communicating with a logistics system to transport the device to the patient.

9. The method of claim 1 further including the step of:
(d) tracking the time following completion of said step (a) and initiating step (b) within a fixed time period.

10. The method of claim 4 wherein at least a portion of said step (a) is performed via a computer over a communications network.

11. The method of claim 10 wherein said communications network includes a modem.

12. The method of claim 10 wherein said communications network is a global computer communications network.

13. The method of claim 11 wherein said communications network is a wireless link.

14. The method of claim 1 wherein said step (c) is performed over a series of at least one private and at least one public network.

15. The method of claim 1 wherein said step (c) comprises:
(c1) determining, based on input from the patient, said authorized recipient; and
(c2) verifying a recipient's authorization to receive data before distributing said data.

16. The method of claim 1 wherein said step (c) is performed using secure communications.

17. The method of claim 4 wherein said step (b) is performed using secure communications.

18. The method of claim 1 wherein step (a) comprises the sub-steps of:
(a1) receiving a request from a first physician for a medical test, subject to verification by an authorized physician; and
(a2) receiving authorization from the authorized physician.

19. The method of claim 18 wherein said step (c) comprises:
(c1) receiving authorization from the patient for the first physician to receive distributions of patient's data; and
(c2) distributing the patient's data to referring physician.

20. A method for collecting data, comprising:
(a) providing a medical test to a patient;
(b) collecting the testing apparatus from the user once the user completes testing; and
(c) distributing test information from the apparatus to authorized recipients.

21. The method of claim 20 wherein said step (a) comprises:
(a1) accepting a request to ship a test device from a requestor; and
(a2) communicating with a logistics system directing shipment of the device to the patient.

22. The method of claim 20 wherein said step (a1) comprises the sub-steps of:
authorizing the requestor to make the request; and
accepting the request.

23. The method of claim 20 wherein said step (a) includes the sub-step of:
providing an id number for the medical test device; and
recording the id number prior to transmitting the test device to the end user.

24. The method of claim 20 wherein said step (a) comprises:
(a1) authorizing a requestor to make a request to transmit the test device to the patient;
(a2) accepting a request from the requestor to transmit the test device to the patient;
(a3) recording a unique identification number for the test device; and
(a4) communicating with a logistics system to transport the device to the patient.

25. The method of claim 20 further including the step of:
(d) tracking the time following completion of said step (a) and initiating step (b) within a fixed time period.

26. The method of claim 20 wherein said step (a) is performed via a computer over a communications network.

27. The method of claim 26 wherein said communications network is a modem.

28. The method of claim 26 wherein said communications network is a global computer communications network.

29. The method of claim 28 wherein said communications network is a wireless link.

30. The method of claim 20 wherein said step (c) is performed over a series of at least one private and one public network.

31. The method of claim 20 wherein said step (c) comprises:
(c1) determining, based on input from the patient, said authorized recipient; and
(c2) verifying a recipient's authorization to receive data before distributing said data.

32. The method of claim 20 wherein said step (c) is performed using secure communications.

33. The method of claim 20 wherein said step (a) is performed using secure communications.

34. The method of claim 20 wherein step (a) comprises the sub-steps of:
(a1) receiving a request from a referring physician for a medical test, subject to verification by an authorized physician; and
(a2) receiving authorization from the authorized physician.

35. The method of claim 34 wherein said step (c) comprises:
(c1) receiving authorization from the patient for the referring physician to receive distributions of patient's data; and
(c2) distributing the patient's data to referring physician.

36. A method for conducting a medical test for an authorized physician, comprising:
(a) collecting an order for a device;
(b) transmitting a medical test device to a user;
(c) extracting test results from the test device;
(d) retrieving the test device from the user subsequent to the user inputting test results into the device; and
(e) distributing test results to authorized recipients.

37. The method of claim 36 wherein said steps are performed sequentially.

38. The method of claim 36 wherein said step (a) is performed using an information server coupled to a public network.

39. The method of claim 36 wherein said step (a) comprises:
(a1) accepting a request to ship a medical test device from the physician; and
(a2) communicating with a shipper directing shipment to the patient.

40. The method of claim 39 wherein said step (a1) comprises the sub-steps of:
verifying the physician is authorized to make the request; and
accepting the request.

41. A system for providing a test system to a patient, comprising:
an interface server including an ordering interface coupled to a communications network accessible by a plurality of computers;
a database server coupled to the interface server;
a logistics system transmitting a medical test to a patient at the direction of a physician accessing the ordering system via the interface server and retrieving the test from the patient upon completion of the test; and
a data transfer system, collecting test results from the medical test and distributing results via a secure mechanism to an authorized recipient.

42. The system of claim 41 wherein the interface server includes an order authorization application.

43. The system of claim 42 wherein the authorization application includes at least a consumer access level, a patient access level, a member access level and a physician access level.

44. The system of claim 41 wherein the database server includes a data structure including a physician record data structure, a manufacturing record database, a client record database and a device record data structure.

45. The system of claim 41 further including a journaling application transferring orders to the logistics system.

46. The system of claim 41 further including an inventory inquiry application communicating with the logistics system.

47. The system of claim 41 wherein the logistics system includes an interface application to a commercial shipper.

48. The system of claim 41 further including a device return verification application, communicating with the logistics system.

49. The system of claim 41 further including a data extraction application.

50. The system of claim 41 further including a data report generator.

51. A method for conducting a medical test for an authorized physician, comprising:
(a) collecting an order for a device input via a computer and received via a communications network;
(b) transmitting a medical test device to a patient at a patient defined location;
(c) extracting test results from the test device;
(d) retrieving the test device from the patient subsequent to the user inputting test results into the device; and
(e) distributing test results to authorized recipients via a secure connection to said communications network.

52. The method of claim 51 wherein said steps (c) and (d) are performed sequentially.

53. The method of claim 51 wherein said step (d) is performed prior to said step (c).

54. The method of claim 51 wherein said step (c) is performed via said network.

55. The method of claim 51 wherein said step (c) is performed via a modem.

56. The method of claim 51 wherein said step (c) is performed via a wireless communications link.

57. The method of claim 51 wherein said communications network is at least partially a public network and said steps (a) and (c) are performed via a secure link through said network.
